(19) United States
(12) Patent Application Publication
(10) Pub. No.: US 2024/0409180 A1
(43) Pub. Date: Dec. 12, 2024

(54) Bicycle Handlebar Grip Assembly, Handlebar, and Bicycle

(71) Applicant: MA Micro Limited, Woking (GB)

(72) Inventors: Yi-Fang Chen, Woking (GB); Zhao-Bo Zhan, Woking (GB); Alexandre Phaneuf, Woking (GB); Chun-Hsun Kao, Woking (GB); Chien-I Chen, Woking (GB); Yu-Lin Chang, Woking (GB); Job Hendrik Stehmann, Woking (GB)

(21) Appl. No.: 18/699,100

(22) PCT Filed: Oct. 7, 2022
(86) PCT No.: PCT/NL2022/050574

§ 371 Date: Apr. 5, 2024

(30) Foreign Application Priority Data
Oct. 7, 2021 (NL) 2029354
Mar. 15, 2022 (NL) 2031300

(51) Int. Cl. B62M 6/45; B62J 50/21; B62J 50/22; B62K 21/12; B62K 21/26; B62K 23/06; B62L 3/02

(52) U.S. Cl. CPC B62M 6/45; B62J 50/22; B62J 50/225; B62K 21/12; B62K 21/26; B62K 23/06; B62L 3/023

(57) ABSTRACT

Provided is a bicycle handlebar grip assembly for mounting on a handlebar of a bicycle handlebar, the bicycle handlebar grip assembly including at least one handgrip body for arranging on a handlebar, such as the end thereof, for a rider to thereby hold the handlebar, fixing means for fixing the bicycle handlebar grip assembly to the handlebar, such as for the purpose of securing or clamping this, and a coupling connection for coupling the handgrip body to the fixing means

### CROSS REFERENCE TO RELATED APPLICATIONS

This application is the United States national phase of International Patent Application No. PCT/NL2022/050574 filed Oct. 7, 2022, and claims priority to The Netherlands Patent Application No. 2029354 filed Oct. 7, 2021 and The Netherlands Patent Application No. 2031300 filed Mar. 15, 2022, the disclosures of which are hereby incorporated by reference in their entireties.

### BACKGROUND OF THE INVENTION

### Field of the Invention

The present invention concerns a bicycle handlebar grip assembly for mounting on the handlebar of a bicycle handlebar. The invention also relates to a bicycle handlebar comprising at least one handlebar grip assembly according to the invention. The invention further relates to a bicycle, comprising at least one bicycle handlebar according to the invention.

### Description of Related Art

It is usual to use a handgrip on a bicycle. It is known in itself to fix a handgrip to the end of a handlebar of a handlebar of a bicycle. Usually this is achieved by using a clamp function between a tight plastic housing which serves as a handgrip, or by means of gluing. It is also provided to fix a handgrip by clamping to the inside of the handlebar. Yet it also occurs that the handgrip body is composed out of a rubber-like material, which has a substantial friction coefficient with respect to the handlebar. However, it is known that these types of solutions are easily taken from the handlebar or prone to vandals which may take the handgrip from the bicycle. Yet, the solutions according to the prior also fail to provide for a simple yet rigid and compact solution.

It is therefore a goal to provide for a handlebar grip assembly which is more compact and/or more practical compared to the prior art. A second goal of the present invention is to provide for a handlebar assembly that allows for more secure attachment of the components. An even further goal is to provide for a handlebar assembly which provides for an improved functionality.

### SUMMARY OF THE INVENTION

In order to improve this prior art, the present invention provides a bicycle handlebar grip assembly for mounting on a handlebar, in particular a handlebar of a bicycle handlebar unit, the bicycle handlebar grip assembly comprising:
at least one handgrip body, said handgrip body arrangeable onto a handlebar, preferably an end portion of said handlebar, for a rider to thereby hold the handlebar, or at least for allowing the rider to hold the handlebar, in particular the handgrip thereof,
at least one mounting structure for, directly or indirectly, (af) fixing the bicycle handlebar grip assembly and/or a bicycle component, such as a brake lever, to the handlebar, in particular for the purpose of securing or clamping said handlebar assembly and/or bicycle component,
preferably a coupling for coupling the at least one handgrip body to the at least one mounting structure.

It is an advantage of the present invention that the handgrip body can be easily and quickly fixed to a handlebar of a bicycle by means of mounting structure. A solid fixing is achieved thanks to the application-specific mounting structure for fixing the bicycle handlebar grip assembly to the handlebar. Preferably, the handgrip body is configured to be attached and/or mounted to at least a portion of the fixing means, for example via at least one coupling connection. Said coupling connection may also and alternatively be referred to as a coupling space and/or a coupling structure and/or coupling element. Said coupling connection and/or coupling space and/or a coupling and/or coupling element may allow for establishing a substantially rigid and/or secure connection between the handgrip body and the fixing means and/or the mounting structure. As such it may be prevented that the handgrip body comes off the handlebar during use of the bicycle, which may cause dangerous situations to the user. Where in this invention reference is made to the fixing means, this may also be referred to as fixing elements and/or mounting elements. Yet, said fixing means may also be conceived as a mounting substrate and/or mounting structure, in particular wherein said mounting substrate and/or mounting structure provides a mounting location for at least one, preferably at least two, more preferably at least three different components, in particular components of the handlebar assembly. This improves the compactness of the design of the handlebar. Also, reducing the amount of separate mounting substrates may increase the overall rigidity, and reduce play between distinct components of the handlebar, which is favourable.

In respect of the present invention, the wording “an end portion of the handlebar” may be understood as a portion of the handlebar where the handgrip body is located. Or if merely a bicycle component is fixed with the mounting structure, where said specific bicycle component may be attached to the handlebar via the mounting structure is located. In the non-limitative case where the bicycle component is a brake lever, this portion may be about 5 cm to 20 cm, in particular somewhere near 15 cm, plus or minus 3 cm, from the end of the handlebar. In general, where reference is made of a connection between the at least one mounting structure and the handgrip body, the wording handgrip body may also be replaced with the bicycle component, in case only a bicycle component is connected to the mounting structure. Thus, it is conceivable that only a bicycle component is connected, preferably via the connection, to the mounting structure, and the handgrip body is mounted to the handlebar separately.

According to a first preferred embodiment, in the bicycle handlebar grip assembly, the coupling is at least partially formed by means of a moulding of the handgrip body at the fixing means during shaping of the handgrip body. Thus, advantageously, a material-specific coupling or fixing is achieved between the handgrip body and the fixing means. This may also be understood as the coupling element which preferably is complementary shaped with respect to the at least one mounting structure and/or the fixing means, preferably during shaping of the handgrip body. The aspect during shaping of the handgrip body is to be interpreted as the complementary shape thereof to be preferably introduced during production of the handgrip body. Said complementary shaped portion may be formed by means of a cut-out portion and/or a recessed portion of the handgrip body. Thus, said coupling element preferably delimits, and/or prohibits a rotational movement of the handgrip body with respect to the handlebar and/or mounting structure or fixing means. This may provide a user with a stable holding surface. For instance, during heavy breaking or rapid acceleration it is preferred that the handgrip body does not slip or rotate since this may cause the user to make unpredictable correctional movements with the handlebar which may yield particularly dangerous situations.

Alternatively, and/or additionally, further preferably, the coupling or coupling element is at least partially formed by means of a glue connection between the mounting structure and the handgrip body and/or the bicycle component. Thus, advantageously, such a connection can be achieved independently of the production process of the handgrip body. Thus, a higher degree of flexibility in the production process can be achieved.

Preferably, the mounting structure comprises at least one protruding tongue, preferably at least two protruding tongues, preferably wherein said at least two protruding tongues protrude mutually spaced apart with respect to the mounting structure. The mounting structure may comprise at least one substantially cylindrical portion. Said cylindrical portion preferably having an inner surface which is at least partially complementary shaped to the outer surface of a part of the handlebar. In particular allowing the cylindrical portion to be allocated around said handlebar. Preferably, said protruding tongues are resilient with respect to the mounting structure, in particular with respect to the cylindrical portion. This may allow for applying the mounting structure to the handlebar. To this end, it is preferred that the at least one protruding tongue is integrally formed with the cylindrical portion of the mounting structure. More preferably wherein said at least two protruding tongues mutually define an opening, in particular a lateral opening of the cylindrical portion of the mounting structure. It is conceivable that at least one component, preferably a brake lever component, such as a brake lever mount element, is configured to be at least partially accommodated between the protruding tongues.

According to a further preferred embodiment, the bicycle handlebar grip assembly comprises at least one contact surface increasing element extending from the mounting structure or fixing means up to or into the handgrip body and/or bicycle component, so as to create an increased (enlarged) contact surface for the purpose of fixing contact and/or the coupling to the handgrip body and/or bicycle component.

According to a preferred embodiment, an inner surface, such as a surface contact element, of the mounting structure is provided with at least one, preferably at least two, protruding locking elements, in particular inwardly protruding locking elements. Preferably, said inwardly protruding locking elements forming a base portion of at least one protruding tongue of the mounting structure. Said locking element may at least partially prevent or delimit a rotational movement of the mounting structure with respect to the handlebar, in particular around the axis of said handlebar. It is preferred that said locking elements, in an installed condition of the mounting structure, at least partially abut a lower side of the handlebar. It is imaginable that said locking elements provided on the inner surface of the mounting structure are oriented on opposing sides of the inner surface of the mounting structure. Said inner surface may be at least partially defined by a cylindrical portion of the mounting structure.

According to a preferred embodiment, the mounting structure, preferably the cylindrical portion, may comprise a radially extending notch. It is conceivable that this notch may form a part of the coupling element. The handgrip body preferably comprises at least one locking lip, in particular wherein said locking lip of the handgrip body is configured to co-act with the radially extending notch of the mounting structure. In a coupled condition the at least one locking lip of the handgrip body is at least partially accommodated in the notch, for at least partially locking the handgrip body in an axial direction with respect to the handlebar. Hence forming the coupling according to the present invention. It is conceivable that that said handgrip body is composed out of an inner grip body and an outer grip body. Said at least one locking lip is preferably provided onto said inner grip body. More preferably, said outer grip body axially extends beyond, preferably encloses, said inner grip body. Preferably, said outer grip body covers at least a portion of an outer surface of said mounting structure, in particular at least covering said notch. Preferably, said locking lip lockingly engages with the notch of the mounting structure, in particular wherein an outer surface of the inner glove body is in contact with the inner surface of the mounting structure.

Such a contact surface creates a better force transmission for the coupling between the handgrip body and/or bicycle component and the fixing means or mounting structure.

According to a further preferred embodiment, the handgrip body has an inner surface for cooperating with an outer surface of the handlebar, wherein these surfaces are preferably configured to prevent rotation of the handgrip around the handlebar, such as by means of a flat side (flat contact surface). More preferably, at least a part of the inner surface of the handgrip body is preferably flat and/or has a non-circular cross-section. Preferably outer surface of the handlebar has a complementary shape. Thus, advantageously, it is provided that one side, such as substantially an underside of the handlebar, is formed at least partially flat or flattened. Such a flat surface relative to an otherwise round tube, in combination with a similar form for the inner surface of the handgrip body, or at least a part of the inner surface of the handgrip body, creates an obstruction to rotation of the handgrip relative to the respective part of the handlebar. Other similarly shaped surfaces may also be provided here, such as a polygonal shape or a ribbed profile. It is also imaginable that an inner surface of said mounting structure comprises at least one locking element, such as a inwardly protruding locking element. Preferably, said inwardly protruding locking element is configured to co-act with an outer surface of the handlebar, in particular to preventing a mutual rotation between the mounting structure and handlebar. It is also imaginable that the handlebar grip assembly is fixed onto the handlebar by means of adhesive and/or mechanically e.g. by means of screws and/or one or more locking elements.

According to a further preferred embodiment, the fixing means or said mounting structure, operate and/or co-act via a clamp connection relative to the handlebar, preferably wherein the clamp connection is partially achieved via a bolt for clamping together at least two parts of the fixing means or mounting structure on one side of the handlebar. That is, an adjustable element is configured to adjust the clamping force of the fixing means or mounting structure with respect to the handlebar, preferably this adjustable element is formed by means of a bolt. However, it is also conceivable that the adjustable element is at least partially formed by a latch, clamp, spring, or similar alternative. Thus, advantageously, a fixing or securing, in particular adjustably fixing or securing, of the bicycle handlebar grip assembly relative to the handlebar is achieved.

Further preferably, the bicycle handlebar grip assembly comprises coupling means, or at least one coupling element, for coupling the fixing means or mounting structure, to at least one sub assembly or bicycle component, such as an operating assembly, a brake lever, a user control device, etcetera, to provide the handlebar grip assembly with additional functionality. In this manner a multifunctional bicycle handlebar grip assembly is obtained. To this end, the mounting structure may comprise at least one accommodating space, for accommodating a mounting portion of said sub assembly of the bicycle. It is imaginable that said accommodating space is at least partially formed by the at least two tongues of the mounting structure. Preferably, the bolt, or the adjustable element, that is used for clamping the mounting structure to the handlebar fixes the sub assembly to said mounting structure. Thus, advantageously, it is achieved both that the sub assembly, such as the operating assembly is rigidly fixed to the handlebar of the bicycle, and the handgrip is rigidly fixed to the handlebar of the bicycle.

According to a further preferred embodiment, the sub assembly may comprise a brake lever, in particular for operating a bicycle brake, such as a disc brake. The brake lever is preferably hingeably connected to the mounting structure, optionally via an coupling element. The sub assembly may additionally comprise a brake fluid reservoir. Preferably, the brake lever is connected or connectable to a mechanical cable for controlling the bicycle brake. The fluid reservoir may be used to lubricate the cable. Thus, advantageously, it is achieved that both the operating mechanism, such as the brake lever, for the handbrake or disc brake or other bicycle brake, and the handgrip or the handgrip body thereof, are fixed to the respective handlebar by means of single fixing means, in particular said (shared) mounting structure. This saves fixing means and/or mounting structures, and space on the handlebar. This also creates a pleasing appearance of the handlebar. By mounting several sub-assemblies, such as the handgrip body as well as the brake lever to the mounting structure, several advantages may be achieved. Firs of all, since it prevents the need for multiple mounting structures, which are often located adjacent to one another, it is possible to reduce the clearance between the multiple mounting structures. Hence, allowing for a more durable and tighter handlebar. Moreover, the amount of separate and often mutually different components is reduced, which may yield a financial benefit in terms of the reduced number of components to be manufactured. In the case of maintenance, the entire unit, that is the mounting structure, may be removed from the handlebar by releasing the single fixing means via said adjustable element, for instance the bolt that fixes the mounting structure to the handlebar. Alternatively, the sub assembly, such as the operating assembly is configured to control a disc brake with cable operation.

Preferably, the handlebar grip assembly comprises at least one cable connector for connecting an electronic and/or mechanical cable, in particular a brake cable, to the bicycle handlebar grip assembly.

Preferably, the handlebar grip assembly, in particular at least one sub assembly thereof, comprises at least one user control device electronically connectable or connected to at least one control unit of the bicycle for controlling said control unit, wherein at least one control unit preferably makes part of the user control device of the bicycle handlebar grip assembly. This user control device may be a very basic user interface, for example defined by one or two buttons to control one or more electronic bicycle components, such as bicycle lights and/or a bicycle electromotor. However, this user control device may also be more sophisticated and/or comprehensive user control device, optionally with a more extensive user interface, for example a touchscreen.

Further preferably, the fixing means or mounting structure cooperate with a part of the sub assembly, such as the operating assembly, a grip part thereof, a housing thereof or a reservoir thereof. Thus, components are saved in many ways.

According to a further preferred embodiment, the clamp connection of the fixing means, in particular the mounting structure, cooperates with the sub assembly, such as the operating assembly or the grip part thereof. Preferably, the bolt can be arranged in a passage opening of the sub assembly, such as an operating assembly or the grip part thereof, or can be fixed thereto via a screw thread arranged therein.

In order to improve the fixing of the bicycle handlebar grip assembly to the handlebar, the handlebar grip assembly preferably comprises a clamping element or filler element for creating a clamp function by means of the bolt connection, wherein the clamping element is configured as a stiffly deformable material such as a tough rubber or plastic. Said clamping element or filler element is preferably resilient. In particular, said clamping element or filler element may be beneficial in case the mounting structure comprises protruding tongues, wherein said clamping element or filler element is at least partially situated between said protruding tongues. This allows the protruding tongues to be forced, in particular via the bolt, to the clamping element or filler element. To this end, it is conceivable that at least one surface of the clamping element or filler element abuts the handlebar, or at last faces towards the handlebar.

Further preferably, the handlebar comprises at least one recess for receiving, in recessed fashion, a part of the handgrip assembly such as a part of the sub assembly or bicycle component, such as the operating assembly, a grip part thereof, a housing thereof or a reservoir thereof. That is, the recess may be at least partially formed by a flattened side of the handlebar. In particular said flattened side at least partially accommodates a part of the handgrip assembly, in particular a part of the sub assembly or bicycle component, preferably the brake lever mount, or the operating assembly, a grip part thereof, a housing thereof or a reservoir thereof. This may allow for a minimalist or more slender, advantageous appearance for the entirety of the handlebar and the handgrip assembly. It moreover may allow for a more rigid connection between the bicycle component and the handlebar. For example, in the case of a disc brake, this creates the impression that the required oil reservoir or brake lever mount is relatively small and can be designed unobtrusively.

According to a further preferred embodiment, the bicycle handlebar grip assembly comprises button fixing means or a button mounting structure for fixing button assembly to said button mounting structure, comprising at least one control button or interactive element. Such an at least one control button may represent a user control device (as described above). Thus, advantageously, it is achieved that both the handgrip body of the handgrip and the button fixing means or the button mounting structure can be fixed to the bicycle by means of single mounting structure. In further combination with said sub assembly, such as an operating assembly, the sub assembly, such as an operating assembly may itself also be fixed to the handlebar by the single mounting structure.

It is conceivable, that the bicycle handlebar grip assembly comprises at least one interactive element, for allowing a user to interact with a part of the bicycle via the interactive element. Preferably, said interactive element allows a user to adjust settings of the bicycle via the handlebar grip assembly. Preferably, allowing the user to adjust settings of a control unit or component of the bicycle. To this end, the u interactive element is preferably connected to one or more control units of the bicycle. Said interactive element may according to a preferred embodiment be at least one, preferably at least two, control buttons. Said at least one button may be accommodated in, or mounted or attached to the button mounting structure. Instead of a button the interactive element may also be embodied as a touch sensitive surface, for allowing a user to swipe over said surface to adjust settings of the bicycle. Yet, the interactive element may also be a joystick, which allows the user to interact with the bicycle. Yet further it is also conceivable that the interactive elements are formed by means of a rotatable button, preferably wherein said button rotates around an axis that is parallel to the handlebar, in particular a section of the handlebar where the mounting structure is located. Instead of adjusting settings, the interactive element may be used for checking settings of the bicycle. For example, for checking the status of the drive battery.

Preferably, the mounting structure comprises at least one interactive element mounting element, preferably at least one interactive element accommodating space. Said interactive element mounting element or accommodating space is preferably substantially upwardly directed, such that the interactive element is, in installed condition, reachable by a user during use of the bicycle. Said interactive element mounting element or interactive element accommodating space, is connected integrally with the mounting structure. Preferably said connection is substantially resilient, which may be realized by means of a cut-out or notch in the wall of said accommodating space and/or interactive element mounting element. Otherwise, it is possible that the interactive element accommodating space or interactive element mounting element may restrict or reduce the flexibility of the mounting element as such, which may make it hard to effectively clamp the mounting structure around the handlebar. In particular since the interactive element mounting element or interactive element accommodating space may locally increase the stiffness of the mounting structure too much, which reflects in its clamping properties. It is imaginable that the interactive element mounting element or interactive element accommodating space comprises at least one through hole, for routing of at least one wire or cable. Preferably, said through hole connects an inner surface of the mounting structure and an interior of the interactive element mounting element or interactive element accommodating space, preferably allowing the cable or wire to reach an interior of the handlebar. Routing said at least one wire or cable essentially entirely through the mounting element increases the weather durability.

Further preferably, the button fixing means or the button mounting element are fixed to or integrated in the fixing means or mounting structure, for fixing the bicycle handlebar grip assembly to the handlebar. This achieves a further simplification or saving of components or material. Preferably, said integration is at least partially resilient.

In order to achieve an optimum mutual arrangement for manual operation, a further preferred embodiment advantageously ensures that the button fixing means or the button mounting element and the coupling means are arranged on opposite sides of the bicycle handlebar grip assembly, preferably wherein the button or interactive element is controllable via a thumb of a user.

According to a further preferred embodiment, the bicycle handlebar grip assembly furthermore comprises a bicycle handlebar display assembly, in particular a handlebar feedback unit, for providing feedback, in particular optical feedback, from a central control unit of the bicycle to a user from the handlebar. This advantageously ensures that as well as the handgrip, such a bicycle handlebar display assembly, e.g., a screen or alphanumeric display, can easily be fixed to the handlebar.

Here, advantageously, it is furthermore provided that the bicycle handlebar display assembly, in particular the handlebar feedback unit, can be arranged between the mounting structure and a part of the handlebar, preferably wherein the handlebar and the bicycle handlebar display assembly have substantially the same cross-section, in particular wherein an exterior surface is substantially flush.

Further preferably, the bicycle handlebar display assembly, in particular the handlebar feedback unit is arranged between the mounting structure and the handgrip body. Alternatively, it is provided that the display assembly may be arranged on the other side, which may be more in the direction of the handlebar. It is advantageously provided that the control buttons, or interactive element in that respect, are situated between the handgrip and the display assembly. Also, advantageously, it is conceivable that the handlebar and the handgrip body, and the bicycle components which may be connected via the mounting structure, substantially have the same diameter, in particular an outer diameter, such that said components, or at least a part thereof, are substantially flush, for an advantageous appearance of the components.

According to a further preferred embodiment, the bicycle handlebar grip assembly comprises at least one cable passage for passing a cable from an exterior of the handlebar to an interior of the handlebar, preferably, the handgrip body at least partially covers said cable passage. Yet, it is also conceivable the fixing means or mounting structure or the coupling, or a sealing elements cooperating with said cable passage in order to cover and/or partially seal said cable passage. Covering the cable passage is beneficial since it may prevent water from entering the handlebar interior and causing electric shortage. Thus a cable connection may be achieved between a central control unit of the bicycle, and/or a decentralized control unit of the bicycle and/or a power supply of the bicycle, and the components which may be fixed by means of the mounting structure.

Preferably said cable passage extends from the interactive mounting structure or button mounting structure towards an end portion of the handlebar. More preferably, said cable passage is at least partially defined by a flattened side and/or inwardly rounded surface of the handlebar. It is imaginable that a portion of the cable passage is defined by the handlebar and the handgrip body. The cable passage may comprise a first portion, which extends at least partially along an exterior of the handlebar and the interior of the handgrip body, and a second portion which extends at least partially along the interior of the handlebar. Preferably, said first and second portion are connected via a connecting portion at an end portion of the handlebar, in particular beyond an end of the handlebar.

The present invention is further related to a mounting structure. Said mounting structure for, directly or indirectly, connecting a handlebar grip assembly, preferably a handlebar grip assembly according to one of the preceding claims, and/or a bicycle component to a handlebar. Same benefits apply to the mounting structure as described with respect to the handlebar grip assembly.

The invention also relates to a bicycle handlebar, comprising at least one bicycle handlebar grip assembly according to the invention. Preferably, the handlebar comprises two of said handlebar grip assemblies arranged at opposite sides of the handlebar. The handlebar is typically mounted onto or into a head tube of the bicycle, wherein the head tube makes part of a frame of the bicycle.

The present invention also concerns an invention relating to a bicycle, in particular an electric bicycle, comprising at least one bicycle handlebar grip assembly according to the invention, and/or at least one handlebar according to the invention. Preferably, the bicycle comprises electric propulsion as the main propulsion or as assistance. Within the context of the present invention, such a bicycle is provided for example with a central on-board computer for controlling sub-systems of the bicycle, such as a BMS, drive motor, communication modules e.g. for GSM, Wi-Fi, Bluetooth, GPS, front and rear lights, automatic transmission and similar. The present invention is here preferably used in combination with a system, designed at the time of this invention, linking the on-board computer and the other components. Here control signals are provided for the sub-systems or accessories of the bicycle by means of a network connection such as a CAN network. The sub-systems or accessories are provided with electrical power via power wires. These sub-systems or accessories are provided with electronics to be able to support this network connection. Preferably, the systems are mutually connected via a wired connection, with for example five connectors comprising earth, screening, power, CAN 1, CAN 2, but for specific components a different division may take place within the concept of this network approach. Such a network approach is for example unsuitable for power transmission from a drive battery to a drive motor, for which a separate power cable is an advantageous solution. Within the concept of this description, the nature of a cable, for which details are not described here, will be understood by a person skilled in the art. Also, for a person skilled in the art, it is understood that the present invention is de-scribed with reference to technical measures. The technical measures provide technical advantages. In addition, it is clear to the person skilled in the art that not only can each technical implementation be performed in many technical ways, but also each technical implementation can be developed with many design possibilities. The present inventors have technically structured the technical implementation as described in the present document on the basis of supplied design values or design language which preceded the technical feasibility of the earlier versions of these design values or design language.

Typically, the bicycle comprises foot pedals, wherein said pedals are, directly or indirectly, connected to the crank set of the bicycle for propelling the bicycle. Prefer-ably, the bicycle is a pedal operable electric bicycle, also referred to as e-bike, pedelec, and speed pedelec. Preferably, the bicycle comprises at least one electromotor to drive at least one wheel of the bicycle. Typically, the bicycle comprises a pedal-operated manpower driven system and an electromotor driven system in parallel to each other, wherein at least one bicycle control unit is configured to control the output of the electromotor driven in response to a pedal depressing force of the manpower driven system.

The present invention may be described by means of the one or more of the following non-limitative clauses:
1. Bicycle handlebar grip assembly for mounting on a handlebar of a bicycle handlebar unit, the bicycle handlebar grip assembly comprising:
at least one handgrip body for arranging on a handlebar, such as the end thereof, for a rider to thereby hold the handlebar,
fixing means for fixing the bicycle handlebar grip assembly to the handlebar, such as for the purpose of securing or clamping this,
a coupling connection for coupling the handgrip body to the fixing means.
2. Bicycle handlebar grip assembly according to clause 1, wherein the coupling connection is formed by means of a moulding of the handgrip body at the fixing means and/or the coupling connection during shaping of the handgrip body.
3. Bicycle handlebar grip assembly according to one or more of the preceding clauses, wherein the coupling connection is formed by means of a glue connection and/or a weld connection between the fixing means and the handgrip body.
4. Bicycle handlebar grip assembly according to one or more of the preceding clauses, comprising at least one contact surface element extending from the fixing means up to or into the handgrip body, so as to create a contact surface for the purpose of fixing contact and/or the coupling connection to the handgrip body.
5. Bicycle handlebar grip assembly according to one or more of the preceding clauses, wherein the handgrip body has an inner surface for cooperating with an outer surface of the handlebar, wherein these are configured to prevent rotation of the handgrip around the handlebar, such as by means of a flat side.
6. Bicycle handlebar grip assembly according to one or more of the preceding clauses, wherein the fixing means operate via a clamp connection relative to the handlebar, preferably wherein the clamp connection can be achieved via a bolt for clamping together two parts of the fixing means on one side of the handlebar.
7. Bicycle handlebar grip assembly according to one or more of the preceding clauses, comprising coupling means for coupling the fixing means to at least one control assembly for another function of the bicycle.
8. Bicycle handlebar grip assembly according to clause 7, wherein the control assembly is configured to control a disc brake comprising a brake fluid reservoir.
9. Bicycle handlebar grip assembly according to clause 7 or 8, wherein the control assembly is configured to control a disc brake with cable operation.
10. Bicycle handlebar grip assembly according to one or more of clauses 7-9, wherein the fixing means cooperate with a part of the control assembly, a grip part thereof, a housing thereof and/or a reservoir thereof.
11. Bicycle handlebar grip assembly according to one or more of clauses 6-10, wherein the clamp connection of the fixing means cooperates with the control assembly or the grip part thereof, preferably wherein the bolt can be arranged in a passage opening of the control assembly or the grip part thereof, or can be fixed thereto via a screw thread arranged therein.
12. Bicycle handlebar grip assembly according to clause 10, comprising a clamping element or filler element for creating a clamp function by means of the bolt connection, wherein the clamping element is configured as a stiffly deformable material such as a tough rubber or plastic.
13. Bicycle handlebar grip assembly according to one or more of the preceding clauses, wherein the handlebar has a recess for receiving, in recessed fashion, a part of the handgrip assembly such as a part of the control assembly, a grip part thereof, a housing thereof or a reservoir thereof.
14. Bicycle handlebar grip assembly according to one or more of the preceding clauses, comprising button fixing means for fixing thereto a button assembly comprising at least one control button for the bicycle.
15. Bicycle handlebar grip assembly according to clause 14, wherein the button fixing means are fixed to or integrated in the fixing means for fixing the bicycle handlebar grip assembly to the handlebar.
16. Bicycle handlebar grip assembly according to clause 14 or 15, wherein the button fixing means and the coupling means are arranged on the bicycle handlebar grip assembly such that they are substantially opposite one another, such as for the purpose of thumb control of a button and finger control of the handbrake.
17. Bicycle handlebar grip assembly according to one or more of the preceding clauses, comprising a bicycle handlebar display assembly for creating visual feedback from a central on-board computer of the bicycle to a rider from the handlebar unit.
18. Bicycle handlebar grip assembly according to clause 17, wherein the bicycle handlebar display assembly can be arranged between the fixing means and the handlebar, preferably wherein the handlebar and the bicycle handlebar display assembly have substantially the same or complementary cross-sections.
19. Bicycle handlebar grip assembly according to clause 17 or 18, wherein the bicycle handlebar display assembly can be arranged between the fixing means and the handgrip body.
20. Bicycle handlebar grip assembly according to one or more of the preceding clauses, comprising a cable passage for passing a cable from the exterior of the handlebar to the interior of the handlebar, preferably wherein this cable passage is closable by means of the handgrip body, the fixing means or the coupling connection, or a sealing means cooperating therewith.

### BRIEF DESCRIPTION OF THE DRAWINGS

The terms FIG., FIGS., Figure, and Figures are used interchangeably in the specification to refer to the corresponding figures in the drawings.

FIG. 1A shows a first embodiment according to the present invention in a front view;

FIG. 1B shows the embodiment of FIG. 1A from a rear view, as seen from the driver;

FIG. 2A shows the embodiment of FIG. 1A, wherein the handgrip is not depicted;

FIG. 2B shows the embodiment of FIG. 1B, wherein the handgrip is not depicted;

FIG. 3 shows the mounting structure according to the invention;

FIG. 4 shows the mounting structure without the mounting bracket;

FIG. 5A shows an embodiment according to the present invention;

FIG. 5B shows the same embodiment as shown in FIG. 5A in a different perspective;

FIG. 5C shows a different embodiment of the same part of the invention as shown in FIGS. 5A and 5B;

FIG. 5D shows the same embodiment as shown in FIG. 5C in a different perspective;

FIG. 6A shows the mounting structure according to the invention;

FIG. 6B shows a button which can be mounted in the mounting structure as shown in FIG. 6A;

FIG. 7 shows steps for assembling the present invention;

FIG. 8 shows an embodiment in which two buttons are provided;

FIG. 9 show an embodiment in which two buttons are provided;

FIG. 10A shows an embodiment wherein the assembly is fixed by single fixing element, such as via a bolt;

FIG. 10B shows a detailed view of the embodiment shown in FIG. 10A.

### DESCRIPTION OF THE INVENTION

Further advantages, features and details of the present invention will be described hereinbelow in greater detail with the aid of one or more preferred embodiments with reference to the appended figures. Similar—but not necessarily identical-components from various preferred embodiments are denoted by the same reference numbers.

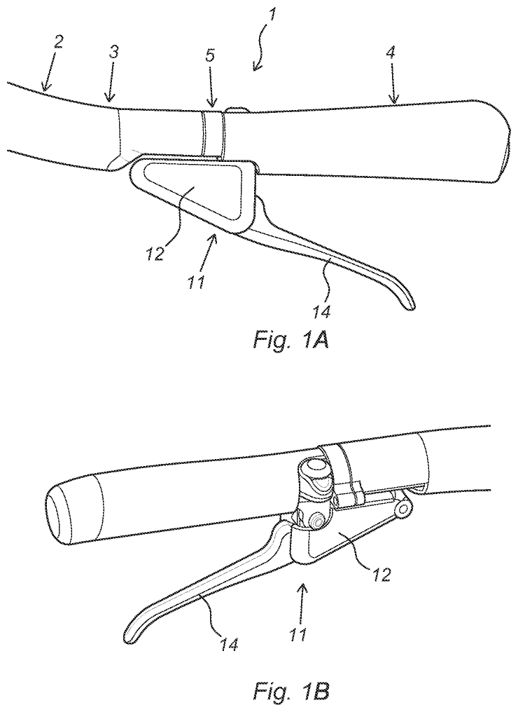

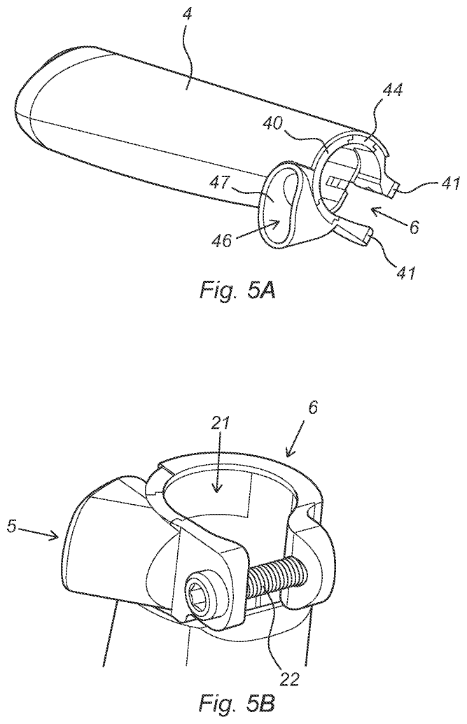

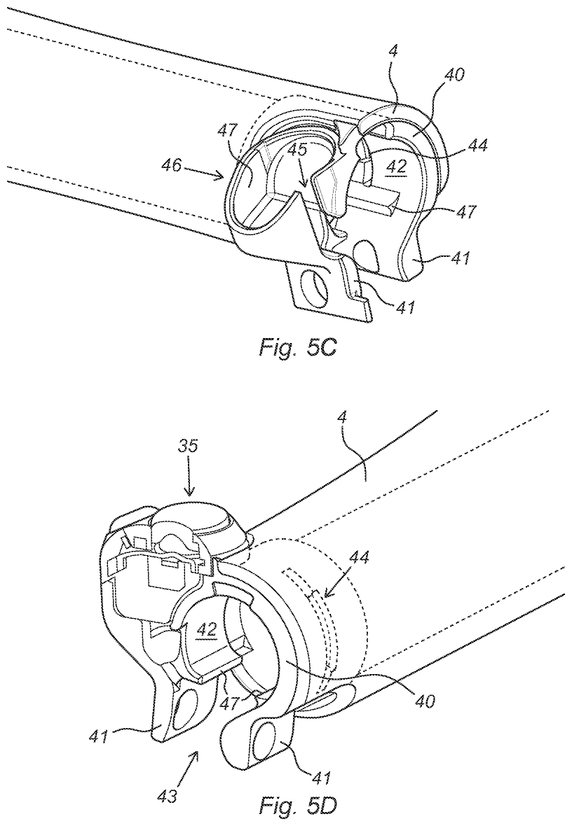

A first preferred embodiment (FIG. 1A and FIG. 1B) according to the present invention concerns a bicycle handlebar grip assembly 1 which is arranged on the handlebar 3 of a bicycle handlebar 2. The bicycle handlebar grip assembly 1 substantially comprises a handgrip body 4, fixing means 5, and a coupling connection 6 (FIGS. 5A-5D).

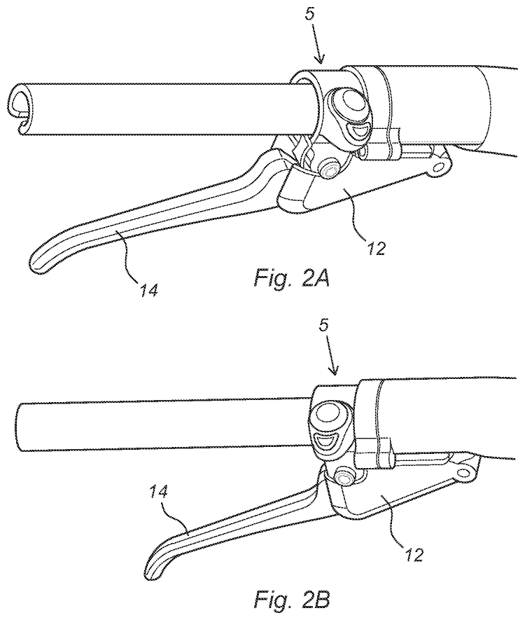

The bicycle handlebar grip assembly provides the advantage that mounting thereof during assembly and/or maintenance is simplified relative to the prior art, because of mounting a bicycle handlebar grip assembly in combination with the handgrip body, the fixing means 5 or mounting structure 5 and a coupling connection 6 or a coupling element 6 or a coupling 6, as well as further preferred elements such as a sub assembly, such as an operating assembly 11, e.g. a sub assembly 11, such as an operating assembly 11 which is configured for operating a disc brake comprising a fluid reservoir 12 and a lever 14. FIG. 2A and 2B show another view of the first embodiment as shown in FIGS. 1A and 1B, wherein, for clarity reasons, the handgrip body 4 is not visualized in order to visualize a terminal portion of the handlebar 3 around which the handgrip 4 is applied, preferably slid.

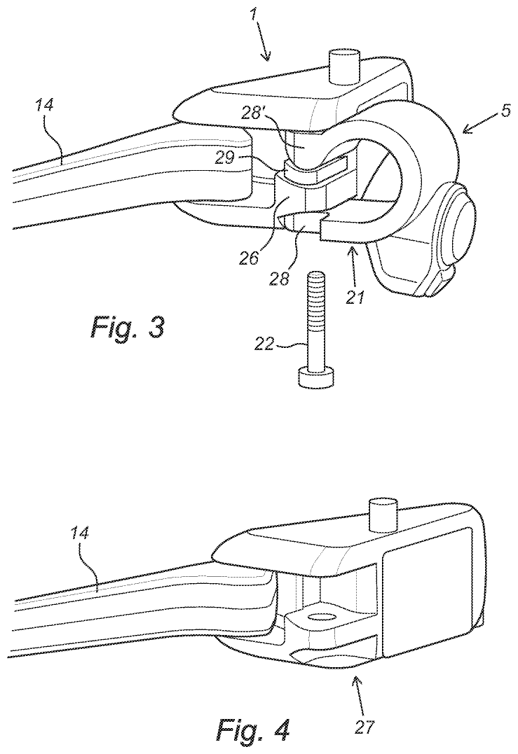

An advantage of the present invention or an embodiment thereof is that the entirety of this combination of components in the assembly can be mounted by means of the fixing means 5 or mounting structure 5. To this end, the fixing means 5 or mounting structure 5 are substantially configured as a bracket 21 (FIG. 3) for surrounding the handlebar 3 or a narrower end part 24 thereof. An advantage of the narrower end part 24 thereof is that the handgrip 4 or the bicycle handlebar grip assembly may have substantially the same cross-sectional shape as a thick middle part 25 of the handlebar 2 or the handlebar 3. Thus advantageously a uniform appearance is created.

The bracket 21, as shown in FIG. 3 and omitted in FIG. 4, fits inside and/or cooperates with a grip part 27 of the housing or a reservoir 12 of the handbrake. By means of a bolt 22, the bracket 21 is tightened or clamped around the handlebar 24. Also, by means of this bolt, the grip part 27 of the handbrake is secured. For this, a filler element 29 (washer) is also provided, which is made of tough but easily deformable rubber or plastic, for clamping the grip part 27 between the ends 28, 28′ of the bracket 21.

FIGS. 5A and 5B show a first embodiment according to the present invention, and FIGS. 5C and 5D show a second embodiment. The figure indicates two protruding tongues 41, preferably wherein said at least two protruding tongues 41 protrude mutually spaced apart with respect to the mounting structure 5. The mounting structure 5 may comprise at least one substantially cylindrical portion 40. Said cylindrical portion 40 preferably having an inner surface 42 which is at least partially complementary shaped to the outer surface of a part of the handlebar. At least one interactive element mounting element 46 or interactive element accommodating space 46 is defined by an upward rim 47. FIG. 5B indicates the mounting structure 5 wherein the bolt 22 is provided through the holes in the protruding tongues 41. Said bolt 22 may alternatively be an adjustable element, which may allow for providing an adjustable clamping force of the mounting structure 5. FIGS. 5C and 5D show a different embodiment. In these figures, the interactive element mounting element 46 or interactive element accommodating space 46 is also at least partially defined by an upward rim 47. However, a cut-out 45 or notch 45 is provided in the upward rim 47. This reduces the stiffness of the accommodating space 46. It has become apparent that if the mounting structure 5 is too stiff it may not properly clamp around the handlebar. Hence, a local notch 45 is introduced to allow the ring-shaped mounting structure 5 to be clamped properly around the handlebar. Furthermore, an inner surface 42 of the cylindrical portion 40 of the mounting structure 5 comprises an inwardly protruding locking element 47. In this instance, two inwardly protruding locking elements 47 are provided on the inner surface 42. This locking element 47 may prevent the mounting structure 5 from rotating or slipping around the handlebar. As can be seen in FIG. 5D, a radially extending notch 44 is provided in the mounting structure 5. It is conceivable that this notch 44 may form a part of the coupling element 6. The handgrip body 4 preferably comprises at least one locking lip, in particular wherein said locking lip of the handgrip body is configured to co-act with the radially extending notch 44 of the mounting structure 5. In a coupled condition the at least one locking lip of the handgrip body 4 is at least partially accommodated in the notch 44, for at least partially locking the handgrip body in an axial direction with respect to the handlebar. Hence forming the coupling 6 according to the present invention. FIG. 5D moreover shows the button assembly 35 being accommodated partially in the interactive element accommodating space 46. Instead of the button shown, it is conceivable that a joystick, touch sensitive area, or rotating button is provided.

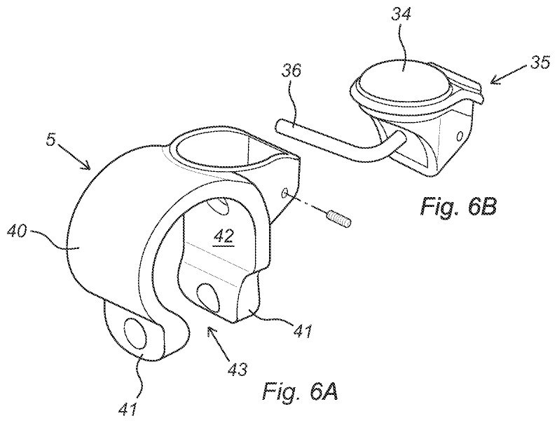

As may be seen in FIGS. 6A and 6B, the mounting structure 5 comprises at least one protruding tongue 41, preferably at least two protruding tongues 41, preferably wherein said at least two protruding tongues 41 protrude mutually spaced apart with respect to the mounting structure 5. The mounting structure 5 may comprise at least one substantially cylindrical portion 40. Said cylindrical portion 40 preferably having an inner surface 42 which is at least partially complementary shaped to the outer surface of a part of the handlebar. In particular allowing the cylindrical portion to be allocated around said handlebar. Preferably, said protruding tongues 41 are resilient with respect to the mounting structure 5, in particular with respect to the cylindrical portion 40. This may allow for applying the mounting structure 5 to the handlebar. To this end, it is preferred that the at least one protruding tongue 41 is integrally formed with the cylindrical portion 40 of the mounting structure 5. More preferably wherein said at least two protruding tongues mutually define an opening 43, in particular a lateral opening 43 of the cylindrical portion 40 of the mounting structure 5. It is conceivable that at least one component, preferably a brake lever component, such as a brake lever mount element 27 (as shown in FIG. 3), is configured to be at least partially accommodated between the protruding tongues 41.

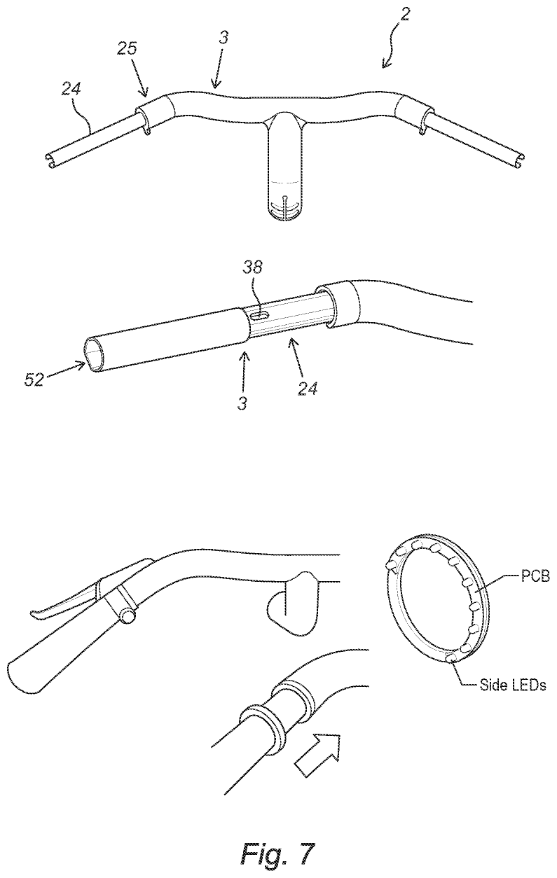

Also, a button module 35 can be mounted on the handlebar together with the fixing means 5 or mounting structure 5. Using the button module 35′, an input can be given to the central on-board computer of the bicycle so that this can react to an operating wish of the rider. The button module comprises a cable 36 for connection to the central on-board computer of the bicycle via the handlebar. For this, a passage opening to the inside of the handlebar is provided, as shown in FIG. 7.

For mutual connection between the bracket 21 of the fixing means 5, FIGS. 5A-5D shows an overlap of material of the handgrip body 4 with the material of the bracket 21. Thus a fixing of the handgrip to the handlebar is achieved by means of fixing of the bracket 21. The figure also shows how the inside of the handgrip body has a flat side 51. This flat side 51 adjoins the flat outer surface 52 of the handlebar 3. This ensures that, over the whole length of the handgrip, twisting of the handgrip is prevented. This also creates extra reinforcement for the fixing by means of the bracket 21.

Also, a button assembly 35 can be arranged on the bracket 21, with a control button 34 for allowing an input to the central on-board computer of the bicycle. Such a button is for example usable for obtaining a boost function of the bicycle, for increasing the motor power of a drive motor thereof, or for a bell or horn function of the bicycle.

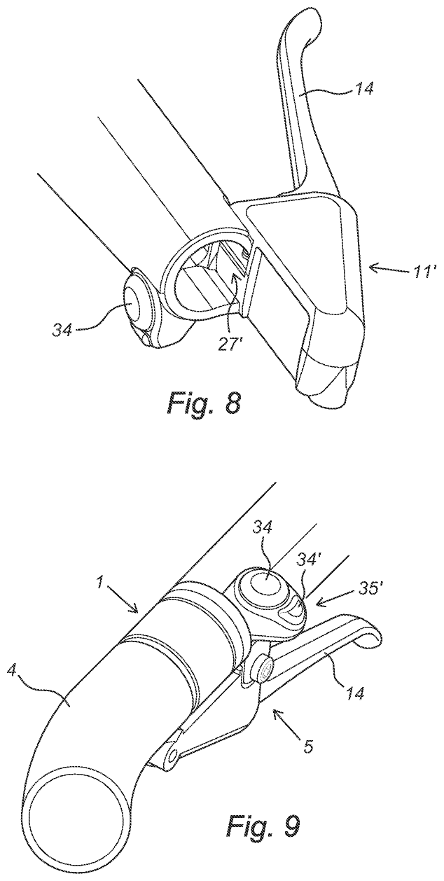

FIG. 8 and FIG. 9 show a variant in which 2 buttons are provided, respectively button 34 and button 34′. In this alternative, a grip part variant 27′ is also provided for an alternative fixing of the handbrake part 11′ to the fixing means 5. Also, a passage opening 38 is provided which is arranged in the handlebar for passage of a cable 36 of the control button.

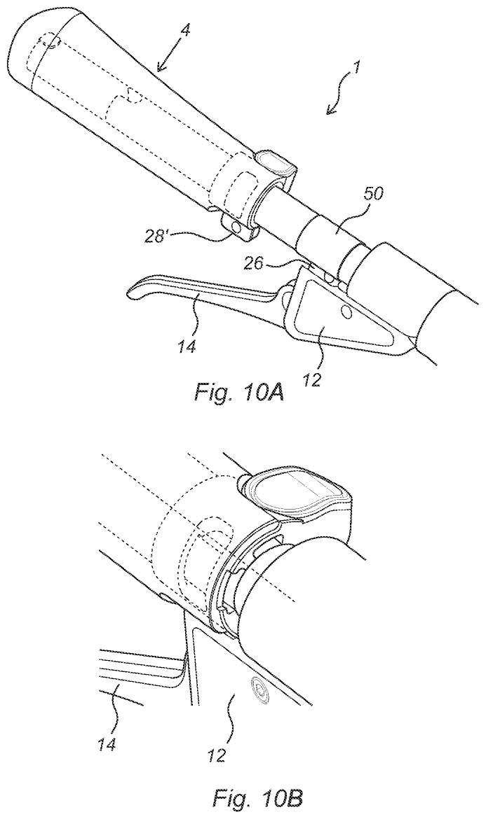

FIG. 10A and FIG. 10B show how a variant, substantially similar to earlier variants, is clamped by means of a clamp with clamp parts 28 (not shown), 28′, between which element 27 of the brake lever 12, 14 is arranged, so that the entire assembly is fixed by single fixing element, such as via a bolt 22.

It also shows how a ring 50 or strip 50 of deformable material, such as a plastic or a rubber, is arranged around the handlebar. The function of this is to increase the grip between the clamping means and the handlebar when the former is tightened. This prevents a disadvantage due to uneven clamping effect.

The inventive concepts described above are illustrated by various illustrative embodiments. It is conceivable that individual inventive concepts, including inventive details, may be used without using other details of the described example. It is not necessary to present examples of all conceivable combinations of the above-described inventive concepts, since a person skilled in the art will understand that numerous inventive concepts may be (re-) combined in order to achieve a specific application and/or alternative embodiment.

The ordinal numbers used in this document, such as ‘first’, ‘second’ and ‘third’, are used purely for identification purposes. The use of expressions such as a “second” component does not necessarily require the simultaneous presence of a “first” component. “Complementary” components are components which are configured to cooper-ate with one another. For this, these components need not however necessarily have complementary forms. The word “comprise” and its derivatives used in this patent publication mean not only “comprise” but also the expressions “contain”, “substantially con-sist of”, “formed by” and derivatives thereof.

It will be clear that the invention is not restricted to the embodiments shown and described here, but numerous variants are possible within the concept of the appended claims, as will be clear to the person skilled in the art. The aesthetic appearance and design of examples or details thereof, in particular as shown in the appended figures, are not technically determined unless stipulated otherwise, and are included merely in order to demonstrate and clarify the inventive concept(s) described herein. The aesthetic appearance of the depicted embodiments is thus a matter of design choice and may be varied or eliminated as desired. The holder of this patent document does not waive other rights which may legally be associated with the information disclosed in this document, including but not limited to copyright and designs connected with, based on and/or derived from the appended figures.

In the above, the prevent invention is described with the aid of a number of preferred embodiments. Different aspects of different embodiments are to be considered as described in combination with one another, with all combinations conceivable for a person skilled in the art on the basis of this document to be read as included therein. These preferred embodiments are not limiting with respect to the scope of protection of this document. The rights sought are defined in the appended claims.

1-27. (canceled)

28. A bicycle handlebar grip assembly for mounting on a bicycle handlebar, the bicycle handlebar grip assembly comprising:
at least one handgrip body, said handgrip body arrangeable onto a bicycle handlebar for allowing a rider to hold the handlebar,
at least one mounting structure for, directly or indirectly, affixing the bicycle handlebar grip assembly to the handlebar,
wherein the at least one handgrip body and the at least one mounting structure are mutually coupled.

29. The bicycle handlebar grip assembly according to claim 28, wherein the at least one handgrip body and the at least one mounting structure are mutually coupled by means of at least one coupling element, which coupling element being complementary shaped with respect to the at least one mounting structure, during shaping of the handgrip body.

30. The bicycle handlebar grip assembly according to claim 28, wherein the coupling between the at least one handgrip body and the at least one mounting structure is at least partially formed by means of a glue connection and/or a weld connection between the mounting structure and the handgrip body.

31. The bicycle handlebar grip assembly according to claim 28, comprising at least one contact surface increasing element extending from the mounting structure up to or into at least one handgrip body, so as for the purpose of the coupling of the handgrip body to the mounting structure.

32. The bicycle handlebar grip assembly according to claim 28, wherein at least one handgrip body has an inner surface configured to co-act with an outer surface of the handlebar, wherein said surfaces are configured to at least partially prevent a mutual rotation of the handgrip and the handlebar, and wherein at least a part of the inner surface of the handgrip body is flat and/or has a non-circular cross-section.

33. The bicycle handlebar grip assembly according to claim 28, wherein the mounting structure is connected to the handlebar via a clamp connection, wherein the clamp connection is at least partially achieved via a bolt for clamping together at least two parts of the mounting structure, and wherein said two parts are oriented on one side of the handlebar.

34. The bicycle handlebar grip assembly according to claim 28, comprising at least one coupling element for coupling the mounting structure to at least one sub assembly of the bicycle handlebar grip assembly, wherein the sub assembly comprises a brake lever and a brake fluid reservoir to, directly or indirectly, control a bicycle brake system, wherein the sub assembly comprises at least one cable connector for connecting an electronic and/or mechanical cable to the bicycle handlebar grip assembly, wherein the sub assembly comprises at least one user control device electronically connectable or connected to at least one control unit of the bicycle for controlling said control unit, and wherein at least one control unit makes part of the user control device of the bicycle handlebar grip assembly.

35. The bicycle handlebar grip assembly according to claim 28, comprising button fixing means or a button mounting structure, said button mounting structure comprising at least one button and/or at least one interactive element configured for controlling the bicycle, wherein the button fixing means or the button mounting structure are fixed to or integrated in the mounting structure for fixing the bicycle handlebar grip assembly to the handlebar, and wherein the button fixing means or the button mounting structure and the coupling elements are arranged on opposite sides of the bicycle handlebar grip assembly, wherein the button or interactive element is controllable via a finger of a user.

36. The bicycle handlebar grip assembly according to claim 33, wherein the clamp connection of the mounting structure co-acts with the sub assembly or the grip part thereof, wherein the bolt can be arranged in a passage opening of the sub assembly or can be fixed thereto via a screw thread arranged therein, comprising a deformable clamping element or filler element, arranged between the two parts of the mounting structure, for creating a clamp function by means of the bolt connection, and wherein the clamping element is configured as a stiffly deformable material.

37. The bicycle handlebar grip assembly according to claim 28, comprising a bicycle handlebar display assembly for providing visual feedback from a central control unit of the bicycle to a user, wherein at least a part of the bicycle handlebar display assembly is arranged between the mounting structure and the handlebar, wherein the handlebar and the bicycle handlebar display assembly have substantially the same or complementary cross-sections, and wherein the bicycle handlebar display assembly is arranged between the mounting structure and the handgrip body.

38. The bicycle handlebar grip assembly according to claim 28, wherein the bicycle handlebar grip assembly comprises at least one cable passage for passing a cable from an exterior of the handlebar to an interior of the handlebar, the handgrip body and/or the mounting structure and/or the coupling, and/or a sealing elements at least partially covers said cable passage.

39. The bicycle handlebar grip assembly according to claim 28, wherein bicycle handlebar grip assembly comprises a bicycle handlebar.

40. The bicycle handlebar grip assembly according to claim 35, wherein the handlebar has a recess for receiving, in recessed fashion, a part of the handgrip assembly.

41. A mounting structure for, directly or indirectly, connecting a handlebar grip assembly according to claim 28 to a handlebar.

42. A bicycle handlebar, comprising at least one bicycle handlebar grip assembly according to claim 28.

43. A bicycle, comprising at least one bicycle handlebar grip assembly according to claim 28, and/or at least one handlebar.

44. The bicycle according to claim 43, wherein the bicycle is a pedal operable electric bicycle.

45. The bicycle according to claim 43, wherein the bicycle comprises at least one electromotor to drive at least one wheel of the bicycle.

46. The bicycle according to claim 43, wherein the bicycle comprises a pedal-operated manpower driven system and an electromotor driven system in parallel to each other, and wherein at least one bicycle control unit is configured to control the output of the electromotor driven in response to a pedal depressing force of the manpower driven system.

47. The bicycle according to claim 46, wherein the handlebar grip assembly comprises at least one user control device for controlling said bicycle control unit.
